(19) United States
(12) Patent Application Publication
(10) Pub. No.: US 2007/0233837 A1
(43) Pub. Date: Oct. 4, 2007

(54) Job assigning device, job assigning method, and computer product

(75) Inventor: Yuji Imai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/480,444

(22) Filed: Jul. 5, 2006

(30) Foreign Application Priority Data
Mar. 29, 2006 (JP) 2006-091455

(51) Int. Cl. G06F 15/173

(52) U.S. Cl. 709/223; 709/238

(57) ABSTRACT

A job assigning device submits a job to a remote environment created for each user on one of nodes that constitute a grid. The job assigning device compares software information indicating software necessary to execute a job with remote-environment information indicating one or more remote environments associated with a user who has requested the job, and software installed in the respective remote environments. Based on the comparison result, the job assigning device preferentially selects a remote environment that requires the least additional software as a destination to submit the job to. The job assigning device submits the job to the remote environment so that the job is to be executed in the remote environment.

### BACKGROUND OF THE INVENTION

1. Field of the Invention

The present invention generally relates to a technology for submitting a job to a remote environment created for each user on one of nodes that constitute a grid. The present invention specifically relates to a technology for, in a grid system where various types of remote environments exist, effectively managing the remote environments in autonomous operation.

2. Description of the Related Art

In recent years, grid computing has been attracting attention as a technology to effectively utilize the performance of an information processing unit. The grid computing technology connects many information processing units via a network, thereby creating a virtual high-performance information processing unit. With the grid computing technology, multiple jobs can be effectively run in parallel.

To effectively operate such a virtual information-processing unit (hereinafter, “grid”) consisting of many information processing units, care needs to taken so that the load is balanced across all the information processing units in the grid. Japanese Patent Application Laid-Open No. 2005-56201, for example, discloses a technology to properly assign jobs based on static performance of each information processing unit and dynamically changing load state.

When a plurality of users share the same grid, security assurance is an important issue. For example, if jobs A and B requested by different users are submitted to the same information processing unit, there is a chance that the details of the processing of the job A are leaked to the user who has requested the job B. One effective approach to avoid such inconvenience could be to create a remote environment for each user in each information processing unit in the grid. The remote environment refers to an environment where a computer program running therein does not have free access to external resources. Examples of the remote environment include a jail environment on a Berkeley Software Distribution (BSD)-based UNiplexed Information and Computing System (UNIX).

However, the job execution environment in a grid is diversifying. Grids were generally used in the past to execute scientific calculations because scientific calculations require high-performance computing. However, now a days the grid is used even for purposes other than scientific calculations. With the progress of such diversification of the job execution environment, it becomes necessary to create a remote environment for each user, and provide various types of remote environments. Especially in a grid consisting of very large number of information processing units, steps to operate and manage remote environments disadvantageously increase.

### SUMMARY OF THE INVENTION

It is an object of the present invention to at least partially solve the problems in the conventional technology.

According to an aspect of the present invention, a job assigning device that receives a job from a first user terminal among a plurality of user terminals and submits the job to a remote environment from among a plurality of remote environments in a first node among a plurality of nodes that constitute a grid includes a software-information obtaining unit that obtains software information indicating software required to execute the job from the first user terminal; a storage unit that stores therein a correspondence of user terminals and remote-environment information of each of the nodes, wherein the remote-environment information indicates one or more remote environments and software installed in each of the remote environments; a remote-environment-information obtaining unit that obtains remote-environment information corresponding to the first user terminal from the storage unit; a comparing unit that compares the remote-environment information obtained by the remote-environment-information obtaining unit with the software information obtained by the software-information obtaining unit and determines a remote environment in which largest number of copies of the software required to execute the job have been installed; a selecting unit that preferentially selects the remote environment identified by the comparing unit as a destination for submitting the job; and a job submitting unit that submits the job to the remote environment selected by the selecting unit in the first node.

According to another aspect of the present invention, a job assigning method of receiving a job from a first user terminal among a plurality of user terminals and submits the job to a remote environment from among a plurality of remote environments in a first-node among a plurality of nodes that constitute a grid includes obtaining software information indicating software required to execute the job from the first user terminal; obtaining remote-environment information corresponding to the first user terminal, wherein the remote-environment information indicates one or more remote environments and software installed in each of the remote environments; comparing obtained remote-environment information with obtained software information and determining a remote environment in which largest number of copies of the software required to execute the job have been installed; preferentially selecting identified remote environment as a destination for submitting the job; and submitting the job to selected remote environment.

According to still another aspect of the present invention, a job executing method of receiving a job from a user terminal and submitting the job to a remote environment in a first node among a plurality of nodes that constitute a grid includes obtaining software information indicating software required to execute the job from the first user terminal; selecting a remote environment as a destination to submit the job to; obtaining remote-environment information corresponding to selected remote environment, indicating software installed in the selected remote environment; and comparing the remote-environment information with the software information to determine whether there is a need to install additional software to execute the job; and installing, when there is a need to install additional software, the additional software in the selected remote environment.

According to still another aspect of the present invention, a computer-readable recording medium stores therein a computer program that cases a computer to implement the above methods.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a grid system according to an embodiment of the present invention;

FIG. 2 is a schematic of an example of remote environments shown in FIG. 1;

FIG. 3 is a detailed functional block diagram of a job assigning device shown in FIG. 1;

FIG. 4 is an example of the data structure of a user master shown in FIG. 3;

FIG. 5 is an example of the data structure of a package master shown in FIG. 3;

FIG. 6 is an example of the data structure of a license master shown in FIG. 3;

FIG. 7 is an example of the data structure of a node master shown in FIG. 3;

FIG. 8 is an example of the data structure of a remote environment master shown in FIG. 3;

FIG. 9 is a detailed functional block diagram of a node shown in FIG. 1;

FIG. 10 is an example of the data structure of a remote environment master shown in FIG. 9;

FIG. 11 is a flowchart for explaining the operation of the job assigning device;

FIG. 12 is a detailed flowchart of a submission-destination selection process shown in FIG. 11;

FIG. 13 is a detailed flowchart of a node selection process shown in FIG. 12;

FIG. 14 is a flowchart for explaining an automatic deletion process for automatically deleting a remote environment performed by the job assigning device;

FIG. 15 is a detailed flowchart of a remote-environment deletion process shown in FIG. 14;

FIG. 16 is a flowchart for explaining the operation of the node to execute a job; and

FIG. 17 is a functional block diagram of a computer that executes a job-assignment program thereby implementing methods, processes, steps etc according to the embodiment.

### DETAILED DESCRIPTION OF THE PREFERRED EMBODIMENTS

Exemplary embodiments of the present invention are explained below in detail with reference to the accompanying drawings.

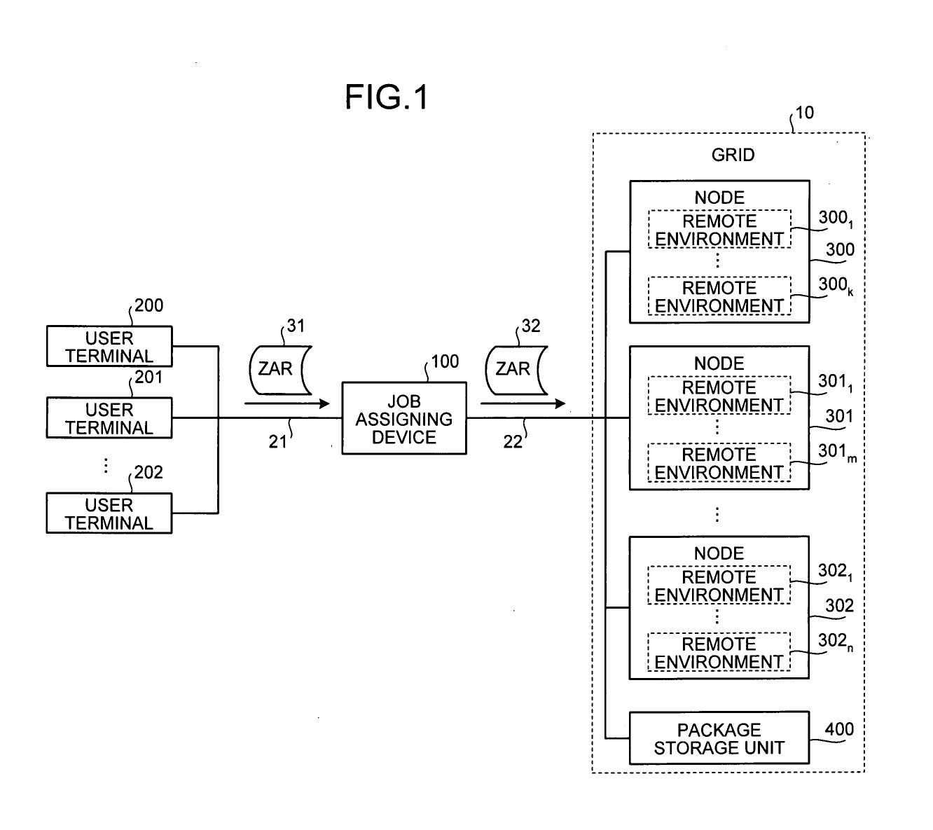

FIG. 1 is a block diagram of a grid system according to an embodiment of the present invention. The grid system includes a job assigning device 100, user terminals 200 to 202, and a grid 10. The job assigning device 100 is connected to the user terminals 200 to 202 via a network 21, and also connected to the grid 10 via a network 22. The grid 10 includes nodes 300 to 302, and a package storage unit 400. The networks 21 and 22 can be segments of the one network. The number of the user terminals and the nodes is not particularly limited, and there can be any number of them in the grid system.

A user operates each of the user terminals 200 to 202. When a user wishes to submit a job to the grid system, he sends the job to the grid system via his user terminal. The job is sent from the user terminal to the job assigning device 100 in the forms of, for example, a Zero Administration Archive (ZAR) file 31. The ZAR file 31 contains a computer program and execution conditions for the computer program.

The nodes 300 to 302 are information processing,units that execute a job. The node 300 manages remote environments 300₁ to 300ₖ. Similarly, the node 301 manages remote environments 301₁ to 301ₘ, and the node 302 manages remote environments 302₁ to 301ₙ. The nodes 300 to 302 execute a job in a remote environment for each user to ensure security.

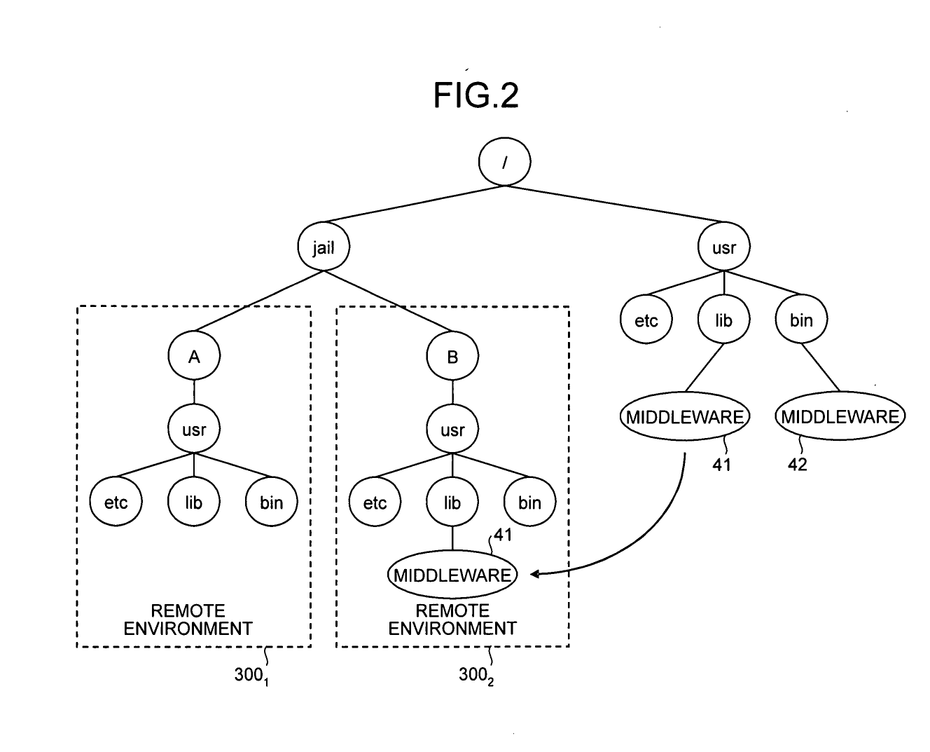

FIG. 2 is a schematic of an example of remote environments. FIG. 2 shows as an example a jail environment on a BSD UNIX system. In FIG. 2, A and B directories are present under a /jail directory. Besides, under each of the A and B directories are copies of a /usr directory and files thereunder required to execute various programs. Through features such as chroot, the directories and files under the directories A and B are used in the remote environments 300₁ and 300₂, respectively. A computer program executed in the remote environment 300₁ or 300₂ cannot freely access a file, etc. outside the remote environment. That is, if each user is provided with a remote environment in which a job requested by the user is executed, information leaks caused by unauthorized access can be prevented.

In the example of FIG. 2, middleware 41 is installed under /usr/lib, while middleware 42 is installed under /usr/bin. It is assumed here that the middleware is required to execute some but not all jobs. If such middleware, library and the like (hereinafter, “middleware, etc.”) not necessary for all jobs are installed in all remote environments, it is simply a waste of disk space, and therefore, undesirable. Accordingly, in the grid system of this embodiment, middleware, etc. are installed in a remote environment only when a job executed in the remote environment requires the use of the middleware, etc.

After middleware, etc. are installed in a remote environment, when the same user requests to execute jobs that require the middleware, etc., control is performed so that the jobs are assigned as much as possible to the remote environment, i.e., the remote environment where the middleware, etc. have already been installed. In FIG. 2, the middleware 41 is installed in the remote environment 300₂. Therefore, if a user corresponding to the remote environment 300₂ requests to execute a job that requires the middleware 41, control is performed so that the job is assigned as much as possible to the remote environment 300₂.

In the case of placing various files in a remote environment, links to the files can be created instead of creating copies of the actual files. Consider that, for example, when the middleware 41 is installed in the remote environment 300₂, a link is established by a static linker or the like without creating a copy of the middleware 41. Then, the middleware 41 can be referred to from the remote environment 300₂.

Such link establishment spares the need to create a copy of a file, thus consuming less disk space. Links are not available for data files updated for each user and setting files that need different setting values for each user. Nevertheless, links are still usable to install programs and libraries.

In the grid system of this embodiment, creation and deletion of a remote environment and addition of middleware, etc. are performed autonomously by the cooperation of the job assigning device 100 and the nodes 300 to 302, and steps to operate and manage remote environments are reduced. The creation and deletion of a remote environment and addition of middleware, etc. are hereinafter explained in detail.

Incidentally, except as a jail environment on a BSD UNIX system, a remote environment can be configured by using various mechanisms and programs to implement a virtual computer. The present invention does not specify the method of implementing a remote environment.

The package storage unit 400 stores therein various middleware, etc. Middleware, etc. required to execute an assigned job are generally installed in the nodes 300 to 302. If middleware, etc. required to execute an assigned job is installed, the nodes 300 to 302 request the package storage unit 400 to send the middleware, etc. thereto.

The job assigning device 100 determines which remote environments on the nodes 300 to 302 in the grid 10 are assigned with respective jobs requested by the user terminals 200 to 202. According to the determination result, the job assigning device 100 submits a job to the grid 10 so that the job is executed in a determined remote environment. A job is submitted, for example, in a ZAR file 32. When selecting a destination to submit a job to, the job assigning device 100 takes into account load on the respective nodes 300 to 302 as in a conventional grid system. In addition, the job assigning device 100 checks middleware, etc. required to execute the job, and also checks whether the nodes 300 to 302 and the remote environments thereon are installed with the middleware, etc.

If the nodes 300 to 302 carry the same amount of load, which is a condition taken into account in the assignment of a job in a conventional grid system, the job assigning device 100 checks middleware, etc. required to execute the job. Accordingly, the job assigning device 100 selects a remote environment that requires no or least installation of additional middleware, etc. from remote environments for the user who has requested the job, and submits the job to the remote environment.

When the remote environment is not installed with the middleware, etc. required to execute the assigned job, the corresponding node (300 to 302) installs the middleware, etc. in the remote environment if the node is already installed with the middleware, etc. If not, the node (300 to 302) receives the middleware, etc. from the package storage unit 400, and installs the middleware, etc. thereon and in the remote environment. That is, as the need for additional middleware, etc. increases, a longer time is taken to install the middleware, etc. Consequently, the installation time causes a delay in executing a job and results in a high consumption of storage capacity.

For this reason, the job assigning device 100 stores information on which user's remote environment exists on which node, and which package, etc. have been installed on which remote environment. Referring to the information, the job assigning device 100 selects a remote environment that requires no or least installation of additional middleware, etc. to submit a job to the remote environment. When no existing remote environment for a user can be selected as a destination to submit a job to due to the load or the like, or there is no existing remote environment for the user, the job assigning device 100 selects a node that requires no or least installation of additional middleware, etc. necessary to execute the job. The job assigning device 100 creates a new remote environment on the selected node, and instructs the node to execute the job in the new remote environment.

When instructed to create a new remote environment in which a job is to be executed, the node (300 to 302) first creates a remote environment including standard files required to execute various programs. After that, when the installation of additional middleware, etc. is required to execute the job, the node (300 to 302) installs the additional middleware, etc. in the manner as previously described. As the need for additional middleware, etc. increases, a longer time is taken to install the middleware, etc. The installation time causes a delay in executing a job and results in a high consumption of storage capacity.

Therefore, the job assigning device 100 stores information on which package, etc. have been installed on which node. Referring to the information, the job assigning device 100 selects a node that requires no or least installation of additional middleware, etc. to create a remote environment on the node.

When selecting a destination to submit a job to, the job assigning device 100 also checks whether middleware, etc. are licensed. Having requested to execute a job that necessitates the use of middleware, etc. requiring a predetermined license, the job assigning device 100 refers to information previously stored about licenses that respective users have acquired. If a user who has requested the job to be executed does not possess the predetermined license, the job assigning device 100 rejects the execution of the job. Even if the user has acquired the predetermined license, when there are license conditions, for example, on the number of central processing units (CPUs), the job assigning device 100 selects a destination to submit the job to so that the middleware, etc. are not to be installed against the license conditions.

It is assumed that a user has acquired a license for a database system, and a license condition is that the database system is available on an information processing unit with up to two CPUs. In this case, when receiving a request from the user for the execution of a job that needs the database system, the job assigning device 100 does not assign the job to any node with more than two CPUs. After submitting the job to a remote environment on a node, the database system cannot be installed in other remote environments because of the number of licenses acquired for the database system. Therefore, when receiving a request from the same user for the execution of a job that needs the database system, the job assigning device 100 always submits the job to the remote environment.

Besides, the job assigning device 100 deletes unnecessary remote environments. For example, if the registration of a user is cancelled, the job assigning device 100 selects one or more remote environments for the user based on information stored therein, and instructs the node (300 to 302) to delete the remote environment(s). In addition, the job assigning device 100 stores information on the last time a job was submitted to each remote environment. The job assigning device 100 checks, at regular intervals, whether there is any remote environment to which a job has not been submitted for more than a predetermined time. If any, the job assigning device 100 instructs the node (300 to 302) to delete the remote environment.

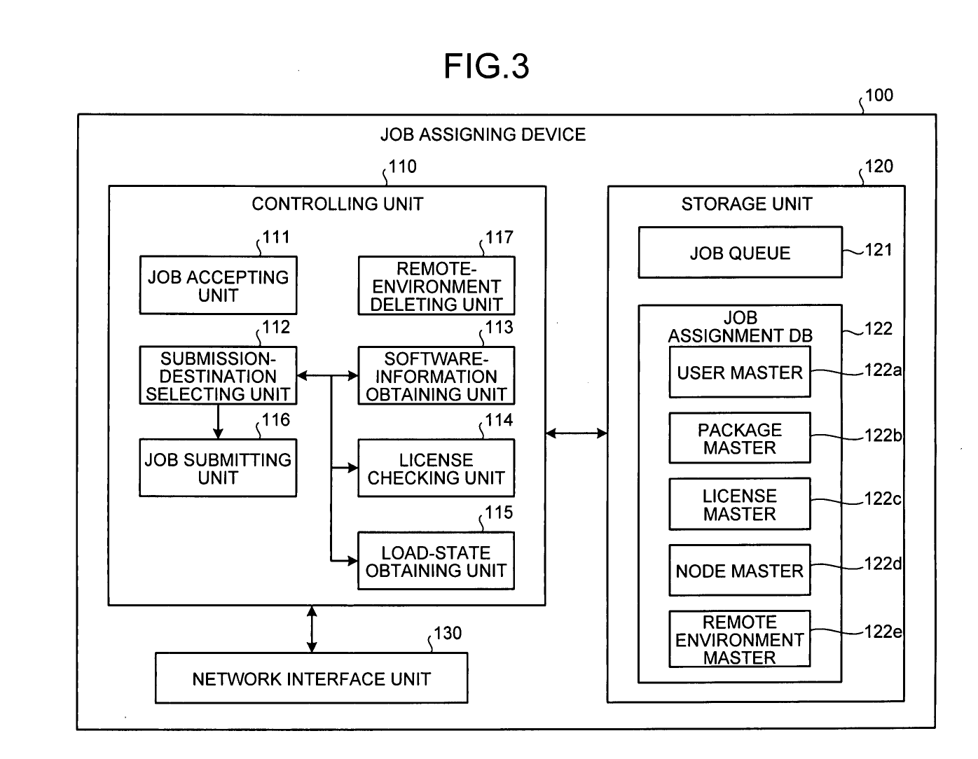

FIG. 3 is a detailed functional block diagram of the job assigning device 100. The job assigning device 100 includes a controlling unit 110, a storage unit 120, and a network interface unit 130.

The controlling unit 110 controls the entire job assigning device 100. The controlling unit 110 includes a job accepting unit 111, a submission-destination selecting unit 112, a software-information obtaining unit 113, a license checking unit 114, a load-state obtaining unit 115, a job submitting unit 116, and a remote-environment deleting unit 117.

The storage unit 120 stores therein a variety of information, and includes a job queue 121 and a job-assignment database (DB) 122. The job queue 121 temporarily stores a job that the job assigning device 100 has received from each of the user terminals 200 to 202. The job assignment DB 122 stores therein information necessary for the submission-destination selecting unit 112, etc. to perform various processes. The job assignment DB 122 includes a user master 122a, a package master 122b, a license master 122c, a node master 122d, and a remote environment master 122e.

The network interface unit 130 is an interface to exchange a variety of information via a network.

The job accepting unit 111 receives a request to execute a job from the user terminals 200 to 202, and places the job in the job queue 121 in the storage unit 120. On receipt of a request to execute a job, the job accepting unit 111 compares a user ID and a password sent from a user with those stored in the user master 122a to authenticate the user. Only when the user is authenticated successfully, the job accepting unit 111 accepts the request. The job accepting unit 111 places the job in the job queue 121 in association with the user ID received from the user.

The submission-destination selecting unit 112 sequentially takes jobs from the job queue 121, and selects a remote environment to which each job is to be submitted. The submission-destination selecting unit 112 instructs the job submitting unit 116 to submit a job to a selected remote environment. When selecting a destination to submit a job to, the submission-destination selecting unit 112 takes into account the necessity of installation of additional middleware, etc., license conditions for middleware, etc. required to execute the job, the load state of each remote environment, and the like. The detailed procedure is described later in which the submission-destination selecting unit 112 selects a destination to submit a job to.

The software-information obtaining unit 113 obtains information on middleware, etc. required to execute a job. The information can be obtained by analyzing a computer program contained in the ZAR file 31, or can be embedded by a user in the ZAR file 31 as part of the additional information to be read therefrom. The software-information obtaining unit 113 obtains the information according to an instruction from the submission-destination selecting unit 112. The software-information obtaining unit 113 sends the obtained information to the submission-destination selecting unit 112 in response to the instruction.

The license checking unit 114 performs various checks to prevent license fraud or violation. More specifically, according to an instruction from the submission-destination selecting unit 112, the license checking unit 114 checks whether middleware, etc. required to execute a job contain the one for which a user, who has requested the job to be executed, does not possess a license. The license checking unit 114 also checks whether a license violation occurs if a job is submitted to a remote environment.

The load-state obtaining unit 115 obtains the load state of respective nodes and remote environments according to an instruction from the submission-destination selecting unit 112. The load-state obtaining unit 115 informs the submission-destination selecting unit 112 of the obtained load state in response to the instruction. Incidentally, among the conventional job assignment criteria, only the load state is used as one of the job assignment criteria in this embodiment. Another or more than one conventional job assignment criterion can be used.

The job submitting unit 116 submits a job to a destination selected by the submission-destination selecting unit 112. When submitting a job to a destination, the job submitting unit 116 sends a list of middleware, etc. required to execute the job to the destination together with the job.

The remote-environment deleting unit 117 deletes a remote environment. To be more precise, if the registration of a user is cancelled, i.e., data on the user is deleted from the user master 122a in the storage unit 120, the remote-environment deleting unit 117 instructs one or more nodes (300 to 302) to delete all remote environments for the user. Besides, the remote-environment deleting unit 117 checks, at regular intervals, whether there is any remote environment where a predetermined time has elapsed since the last time a job was submitted thereto. If any, the remote-environment deleting unit 117 instructs the node (300 to 302) to delete the remote environment.

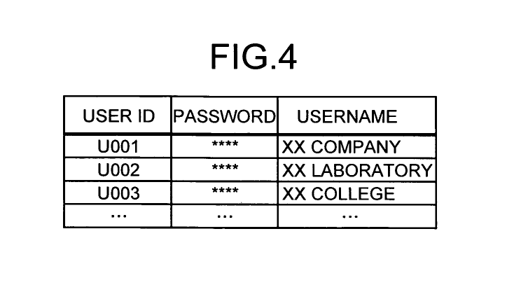

The user master 122a previously stores therein information on users of the grid system. FIG. 4 is an example of the data structure of the user master 122a. The user master 122a contains, for example, items such as user ID, password, and username. Such data are registered in the user master 122a with respect to each user. The user ID is an ID code that uniquely identifies a user. The password is used in combination of the user ID to authenticate a user. The username indicates the name of a user.

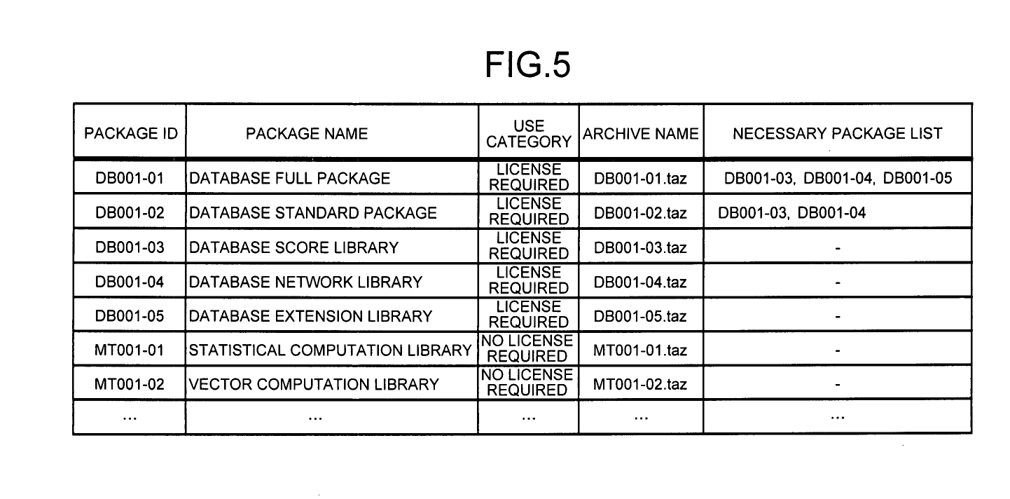

The package master 122b previously stores therein information on packages. A package is a unit for organizing or managing various files that constitute middleware, etc. FIG. 5 is an example of the data structure of the package master 122b. The package master 122b contains, for example, items such as package ID, package name, use category, archive name, and necessary package list. Such data are registered in the package master 122b with respect to each package. The package ID is an ID code that uniquely identifies a package. The package name indicates the name of a package. The use category indicates “License Required” when a corresponding package requires a license, and “No License Required” when a corresponding package does not require a license. The archive name is the name of a file that contains various files and an install program, etc. required to install a corresponding package. The necessary package list is a list of other packages necessary to install a corresponding package.

When sending obtained information on middleware, etc. required to execute a job to the submission-destination selecting unit 112 in response to an instruction, the software-information obtaining unit 113 sends the information in the form of a list of package IDs. The software-information obtaining unit 113 refers to the necessary package list, and also sends package IDs of packages that the middleware, etc. depends on as the response. If, for example, a package with a package ID of DB001-01 is required to execute a job, a response from the software-information obtaining unit 113 contains package IDs: DB001-03, DB001-04, and DB001-05 set in the corresponding necessary package list in the package master 122b. In this manner, by considering the dependency on each package, the job assigning device 100 accurately acquire information on middleware, etc. that need to be installed in a remote environment.

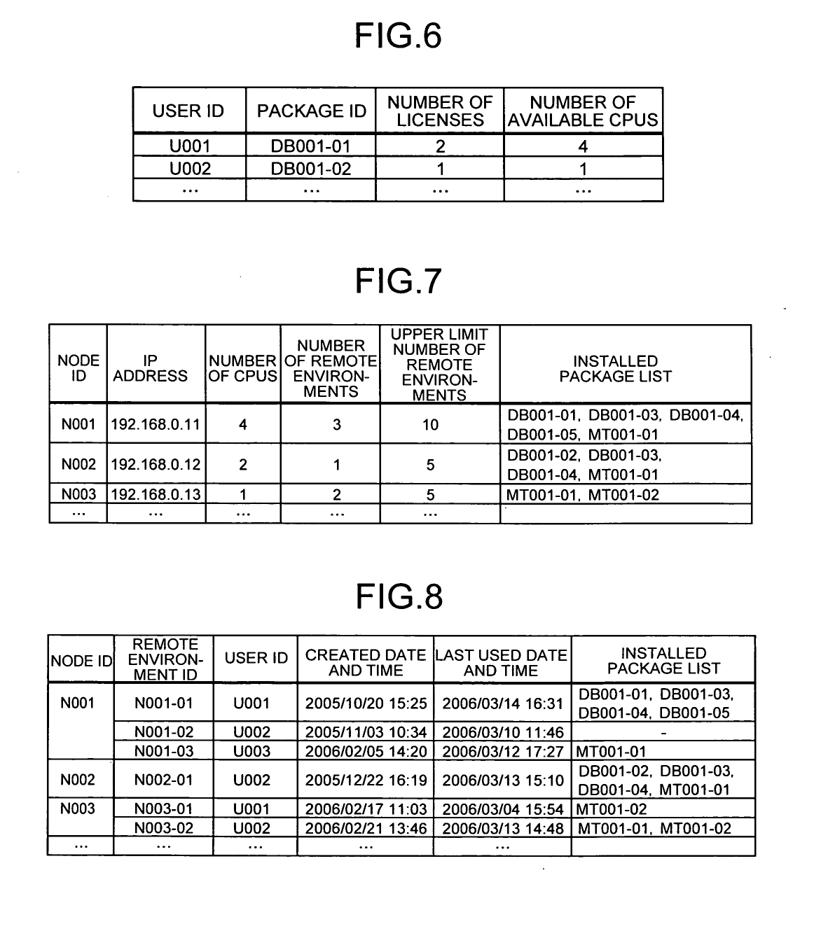

The license master 122c previously stores therein information on licenses that users have acquired. FIG. 6 is an example of the data structure of the license master 122c. The license master 122c contains, for example, items such as user ID, package ID, the number of licenses, and the number of available CPUs. A plurality of data can be registered with respect to each user ID. The user ID is an ID code that uniquely identifies a user, and corresponds to that in the user master 122a. The package ID is an ID code that uniquely identifies a package, and corresponds to that in the package master 122b. The number of licenses indicates the number of licenses that a user has acquired for a package. The number of available CPUs indicates the maximum allowable number of CPUs, defined by a license, in a node on which a corresponding package can be installed.

Referring to FIG. 6, the first line, for example, indicates U001 as the user ID, DB001-01 as the package ID, 2 as the number of licenses, and 4 as the number of available CPUs. This means that a user with a user ID of U001 can install a package with a package ID of DB001-01 on up to two nodes each having not more than four CPUs for use.

The node master 122d previously stores therein information on nodes in the grid. FIG. 7 is an example of the data structure of the node master 122d. The node master 122d contains, for example, items such as node ID, internet protocol (IP) address, the number of CPUs, the number of remote environments, the upper limit number of remote environments, and installed package list. Such data are registered in the node master 122d with respect to each node. The node ID is an ID code that uniquely identifies a node. The IP address is an address assigned to a node. The number of CPUs indicates the number of CPUs in a node, the number of remote environments indicates the number of remote environments that have already been created on a node. The upper limit number of remote environments indicates the maximum number of remote environments that can be created on a node. The installed package list is a list of packages that have already been installed on a node.

Among these items, the number of remote environments is updated by the submission-destination selecting unit 112 and the remote-environment deleting unit 117. Besides, the installed package list is updated by the submission-destination selecting unit 112.

When no existing remote environment can be selected as a destination to submit a job to due to the load state or the like, the submission-destination selecting unit 112 selects a node based on several conditions. The submission-destination selecting unit 112 instructs the node to create a new remote environment and execute the job in the new remote environment. One of the conditions is that the number of remote environments be less than the upper limit number of remote environments defined in the node master 122d. Another of the conditions is that the installed package list contain a large number of package IDs corresponding to middleware, etc. required to execute a job. The conditions can include the load to be produced and that a license violation do not occur if a node is installed with software.

Having selected a node on which a new remote environment is to be created to execute a job, the submission-destination selecting unit 112 adds one to the number of remote environments corresponding to the node in the node master 122d. Additionally, the submission-destination selecting unit 112 updates the installed package list corresponding to the node so that the installed package list contains all package IDs corresponding to middleware, etc. required to execute the job. At the point the node is selected, a new remote environment has not yet been created on the node, and installation of additional middleware, etc. has not been performed. However, if the update is performed after the completion of these processes, the submission-destination selecting unit 112 cannot appropriately select a destination to which a similar job requested by the same user is to be submitted until the processes complete. Therefore, the submission-destination selecting unit 112 updates the node master 122d on selection of a node. On the other hand, after instructing a node to delete a remote environment, the remote-environment deleting unit 117 subtracts one from the number of remote environments corresponding to the node in the node master 122d.

The remote environment master 122e stores therein information on remote environments on each node. FIG. 8 is an example of the data structure of the remote environment master 122e. The remote environment master 122e contains, for example, items such as node ID, remote environment ID, user ID, created date and time, last used date and time, and installed package list. Such data are registered in the remote environment master 122e with respect to each remote environment. The node ID is an ID code that uniquely identifies a node, and corresponds to that in the node master 122d. The remote environment ID is an ID code that uniquely identifies a remote environment. The user ID is an ID code that uniquely identifies a user corresponding to each remote environment, and corresponds to that in the user master 122a. The created date and time indicates the date and time when a remote environment was created. The last used date and time indicates the last time a job was submitted to a remote environment. The installed package list is a list of packages that have already been installed in a remote environment.

The submission-destination selecting unit 112 registers data in the remote environment master 122e when having selected a node on which a new remote environment is to be created to execute a job. Besides, the remote-environment deleting unit 117 deletes data corresponding to one or more remote environments after instructing a node to delete the remote environment(s).

As previously described, when no existing remote environment can be selected as a destination to submit a job to due to the load state or the like, the submission-destination selecting unit 112 selects a node based on several conditions. The submission-destination selecting unit 112 obtains a remote environment ID for a new remote environment, and registers new data in the remote environment master 122e using the remote environment ID. The submission-destination selecting unit 112 specifies the remote environment ID to instruct the job submitting unit 116 to submit the job to the remote environment.

In addition, each time selecting a remote environment to which a job is to be submitted, the submission-destination selecting unit 112 updates the last used date and time corresponding to the selected remote environment to the current date and time. Further, the submission-destination selecting unit 112 updates the installed package list corresponding to the remote environment so that the installed package list contains all package IDs corresponding to middleware, etc. required to execute the job. At the point a remote environment is selected, installation of additional middleware, etc. has not been performed. However, if the update is performed after the completion of the installation, the submission-destination selecting unit 112 cannot appropriately select a destination to which a similar job requested by the same user is to be submitted until the installation completes. Therefore, the submission-destination selecting unit 112 updates the remote environment master 122e on selection of a remote environment.

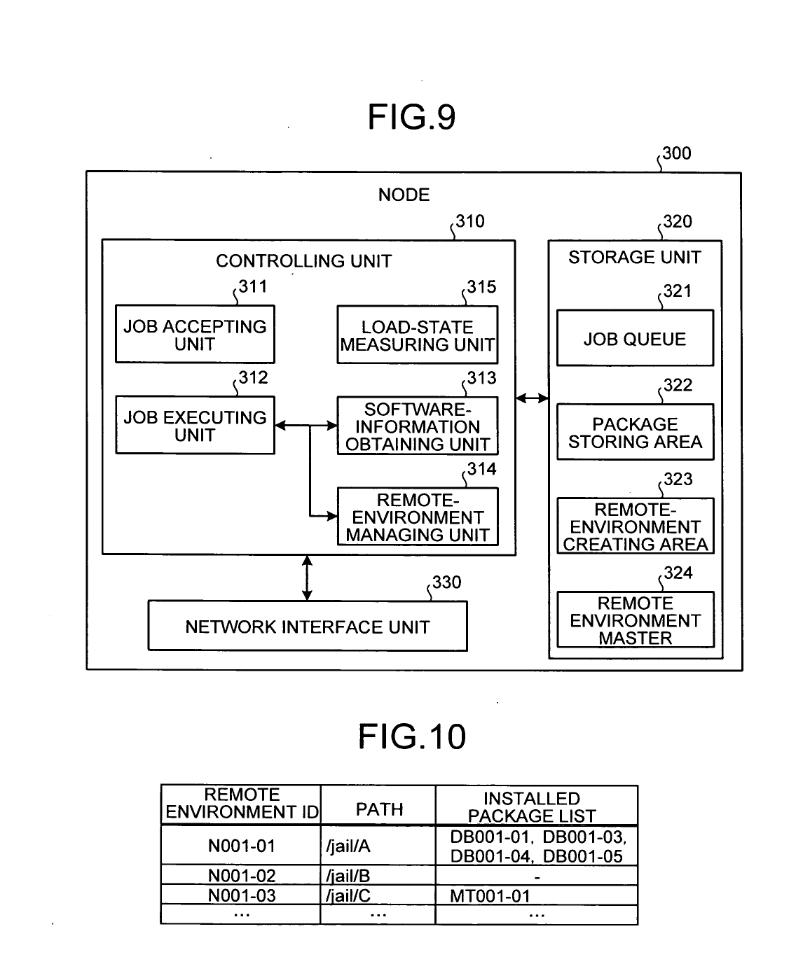

In the following, the construction of the nodes 300 to 302 is explained. The nodes 300 to 302 are of like construction and thus but one of them, for example, the node 300 is described in detail. FIG. 9 is a detailed functional block diagram of the node 300. The node 300 includes a controlling unit 310, a storage unit 320, and a network interface unit 330.

The controlling unit 310 controls the entire node 300. The controlling unit 310 includes a job accepting unit 311, a job executing unit 312, a software-information obtaining unit 313, a remote-environment managing unit 314, and a load-state measuring unit 315.

The storage unit 320 stores therein a variety of information, and includes a job queue 321, a package storing area 322, a remote environment creating area 323, and a remote environment master 324. The job queue 321 temporarily stores a job that the node 300 has received from the job assigning device 100. The package storing area 322 stores various files required to execute programs. The remote environment creating area 323 is an area where a remote environment is created.

The remote environment master 324 stores therein information on remote environments on each node. FIG. 10 is an example of the data structure of the remote environment master 324. The remote environment master 324 contains, for example, items such as remote environment ID, path, and installed package list. Such data are registered in the remote environment master 324 with respect to each remote environment. The remote environment ID is an ID code that uniquely identifies a remote environment, and corresponds to that in the remote environment master 122e in the job assigning device 100. The path indicates the location where a remote environment is created. The installed package list is a list of packages that have already been installed in a remote environment.

The network interface unit 330 is an interface to exchange a variety of information via a network.

The job accepting unit 311 receives a request to execute a job from the job assigning device 100, and places the job in the job queue 321 in the storage unit 320. The job accepting unit 311 places the job in the job queue 321 in association with a remote environment ID specified in the received request. The remote environment ID specifies a remote environment where the job is to be executed.

The job executing unit 312 sequentially takes jobs from the job queue 321, and executes a job in a remote environment indicated by a remote environment ID associated with the job. The job executing unit 312 informs the job assigning device 100 of the result of the execution in response to a request. Also, the job executing unit 312 refers to the remote environment master 324, and, when any data therein does not correspond to a remote environment ID associated with a job, the job executing unit 312 instructs the remote-environment managing unit 314 to create a new remote environment. Further, prior to executing a job, the job executing unit 312 instructs the software-information obtaining unit 313 to obtain information on middleware, etc. required to execute the job, and instructs the remote-environment managing unit 314 to install additional middleware, etc. in a remote environment.

The software-information obtaining unit 313 obtains information on middleware, etc. required to execute a job. The information can be obtained by reading a list of middleware, etc. sent with a job. The software-information obtaining unit 313 obtains the information according to an instruction from the job executing unit 312. The software-information obtaining unit 313 sends the obtained information to the job executing unit 312 in response to the instruction.

The remote-environment managing unit 314 creates a remote environment, installs middleware, etc. in a remote environment, and deletes a remote environment. When instructed to create a remote environment by the job executing unit 312, the remote-environment managing unit 314 creates a new remote environment, and registers this information in the remote environment master 324.

When instructed to install additional middleware, etc. by the job executing unit 312, the remote-environment managing unit 314 compares information on middleware, etc. required to execute a job with the installed package list stored in the remote environment master 324. If there are any middleware, etc. that need to be additionally installed, the remote-environment managing unit 314 obtains the necessary middleware, etc. from the package storing area 322, and installs the middleware, etc. The remote-environment managing unit 314 registers this information in the remote environment master 324. Each time installing middleware, etc. in a remote environment, the remote-environment managing unit 314 updates the installed package list corresponding to the remote environment in the remote environment master 324 so that the installed package list contains all package IDs corresponding to middleware, etc. installed in the remote environment.

If the necessary middleware, etc. are not present in the package storing area 322, the remote-environment managing unit 314 requests the package storage unit 400 to send the middleware, etc. Having received the middleware, etc., the remote-environment managing unit 314 stores the middleware, etc. in the package storing area 322, and thereafter, installs the middleware, etc. in a remote environment where the job is to be executed.

Upon installing additional middleware, etc. in a remote environment, links to files in package storing area 322 can be created in the remote environment rather than copies of the actual files to reduce the consumption of storage capacity. Besides, when instructed to delete one or more remote environments by the remote-environment deleting unit 117 in the job assigning device 100, the remote-environment managing unit 314 deletes the remote environment(s), and deletes data corresponding to the remote environment(s) from the remote environment master 324.

The load-state measuring unit 315 measures the load state of a node or remote environments on the node, in response to a request from the load-state obtaining unit 115 in the job assigning device 100, and informs the load-state obtaining unit 115 of the obtained load state.

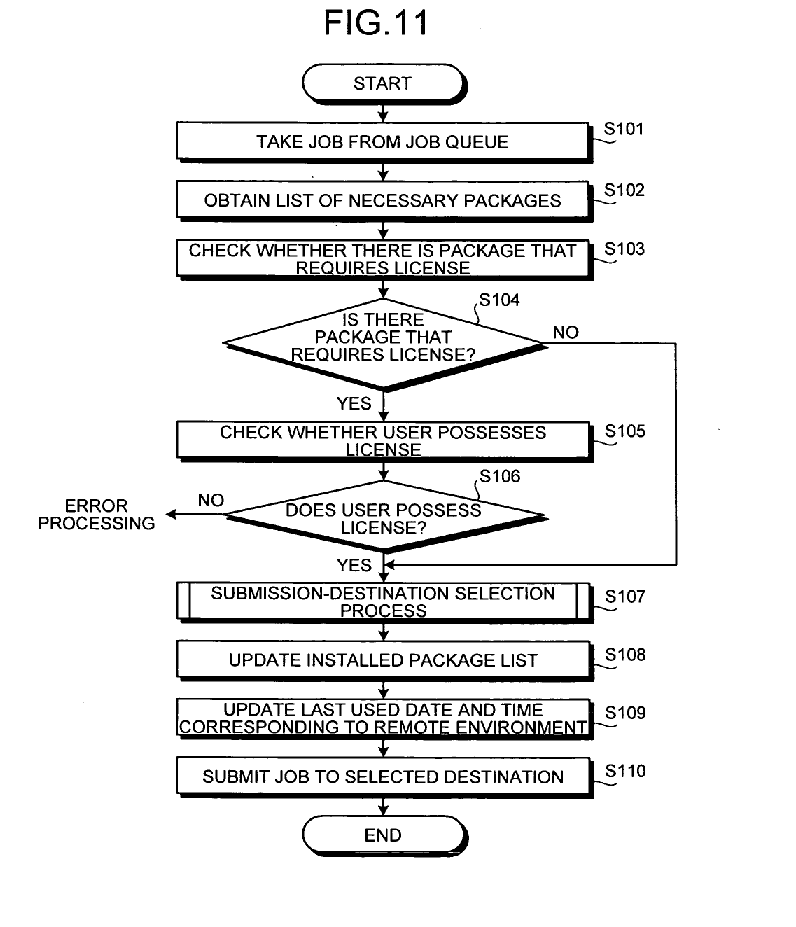

FIG. 11 is a flowchart for explaining the operation of the job assigning device 100. The flowchart shows the process from when the job assigning device 100 takes a job from the job queue 121 until when the job assigning device 100 submits the job. The job assigning device 100 repeats the process.

First, the submission-destination selecting unit 112 takes a job from the job queue 121 (step S101), and instructs the software-information obtaining unit 113 to obtain a list of packages (package list) required to execute the job (step S102). Then, the submission-destination selecting unit 112 instructs the license checking unit 114 to check whether the package list contains middleware, etc. for which a user, who has requested the job to be executed, does not possess a license. According to the instruction from the submission-destination selecting unit 112, the license checking unit 114 first checks whether the package list contains the one that requires a license referring to the package master 122b (step S103). If any (YES at step S104), the license checking unit 114 checks whether the user possesses a license to use the package referring to the license master 122c (step S105).

If the user does not possess the license (NO at step S106), the license checking unit 114 informs the submission-destination selecting unit 112 of this fact. Accordingly, the submission-destination selecting unit 112 performs error processing, and terminates the process for the job. In this error processing, for example, the job is cancelled, and a user terminal, which has requested the job to be executed, is informed of the license violation.

If the package list contains no package that requires a license (NO at step S104), or if the user possesses the license to use the package (YES at step S106), the license checking unit 114 informs the submission-destination selecting unit 112 that there is no license problem. Accordingly, the submission-destination selecting unit 112 performs the submission-destination selection process, which is described hereinafter, to select a destination: a node on a remote environment, to which the job is to be submitted (step S107).

After that, the submission-destination selecting unit 112 updates the installed package list corresponding to the node in the node master 122d and the installed package list corresponding to the remote environment in the remote environment master 122e so that the installed package lists contain package IDs of all packages in the package list obtained at step 102 (step S108). The submission-destination selecting unit 112 updates the last used date and time corresponding to the remote environment in the remote environment master 122e to the current date and time (step S109). The submission-destination selecting unit 112 instructs the job submitting unit 116 to submit the job to the destination selected at step S107 with the package list (step S110).

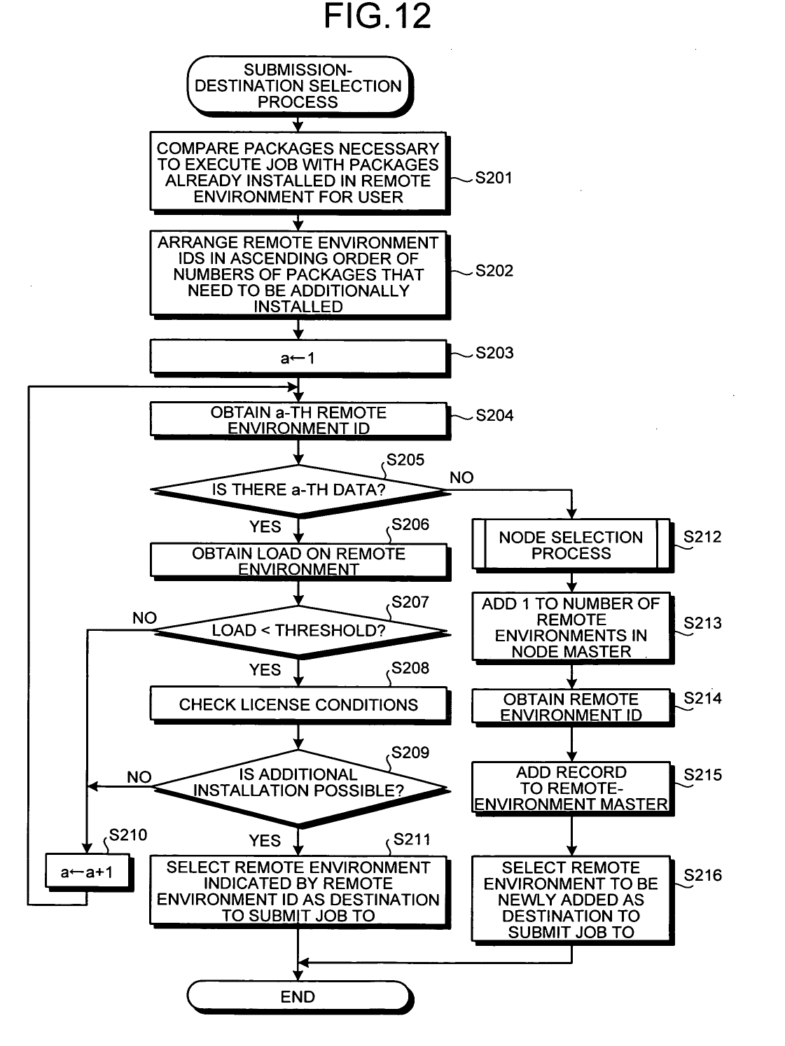

FIG. 12 is a detailed flowchart of the submission-destination selection process at step S107 in FIG. 11. Having been informed by the license checking unit 114 that there is no license problem, the submission-destination selecting unit 112 compares installed package lists in the remote environment master 122e corresponding to a user ID of the user who has requested the job with the package list obtained at step S102 (step S201). The submission-destination selecting unit 112 arranges corresponding remote environment IDs in the remote environment master 122e in ascending order of the number of packages that need to be additionally installed (step S202).

The submission-destination selecting unit 112 initializes a variable a to 1 (step S203), and try to obtain the a-th remote environment ID from the arranged remote environment IDs (step S204). If the a-th remote environment ID can be obtained (YES at step S205), the submission-destination selecting unit 112 instructs the load-state obtaining unit 115 to obtain the load on a remote environment corresponding to the remote environment ID (step S206). When the obtained load is higher than a predetermined threshold (NO at step S207), the submission-destination selecting unit 112 adds 1 to the variable a (step S210), and returns to step S204 in an attempt to obtain the next remote environment ID.

When the obtained load is lower than a predetermined threshold (YES at step S207), the submission-destination selecting unit 112 instructs the license checking unit 114 to check whether a license violation occurs if the remote environment is selected as a destination to submit the job to. According to the instruction from the submission-destination selecting unit 112, the license checking unit 114 checks whether, if all the packages in the package list are installed in the remote environment, it is a violation of license conditions, for example, on the number of licenses (step S208). When it is determined that a licenses violation is to occur (NO at step S209), the license checking unit 114 informs the submission-destination selecting unit 112 of this fact. The submission-destination selecting unit 112 adds 1 to the variable a (step S210), and returns to step S204 in an attempt to obtain the next remote environment ID.

When it is determined that a licenses violation is not to occur (YES at step S209), the license checking unit 114 informs the submission-destination selecting unit 112 that there is no license problem. Accordingly, the submission-destination selecting unit 112 selects the remote environment indicated by the remote environment ID obtained at step S204 as a destination to submit the job to (step S211).

On the other hand, if the a-th remote environment ID cannot be obtained from the arranged remote environment IDs, i.e., when there is no existing remote environment to which the job is to be submitted (NO at step S205), the submission-destination selecting unit 112 performs the node selection process, which is described hereinafter, to select a node on which a new remote environment is to be created (step S212).

The submission-destination selecting unit 112 adds 1 to the number of remote environments corresponding to the selected node in the node master 122d (step S213). The submission-destination selecting unit 112 obtains a remote environment ID for the new remote environment (step S214), and registers new data in the remote environment master 122e (step S215). Thus, the submission-destination selecting unit 112 selects the remote environment, which is to be newly added, as a destination to submit a job to (step S216).

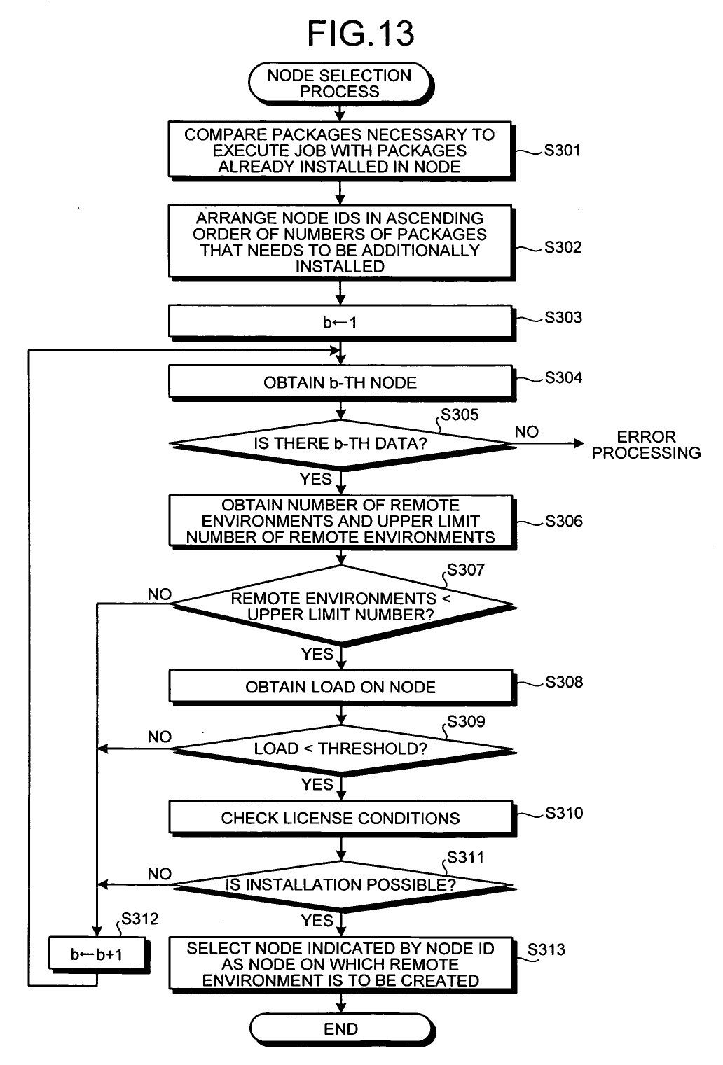

FIG. 13 is a detailed flowchart of the node selection process at step S212 in FIG. 12. When there is no existing remote environment to which a job is to be submitted, the submission-destination selecting unit 112 compares installed package lists in the node master 122d with the package list obtained at step 102 (step S301). The submission-destination selecting unit 112 arranges node IDs in the node master 122d in ascending order of the number of packages that need to be additionally installed (step S302).

The submission-destination selecting unit 112 initializes a variable b to 1 (step S303), and tries to obtain the b-th node ID from the arranged node IDs (step S304). If the b-th node ID can be obtained (YES at step S305), the submission-destination selecting unit 112 obtains from the node master 122d data on the number of remote environments and the upper limit number of remote environments corresponding to the node ID (step S306). The submission-destination selecting unit 112 compares the number of remote environments to the upper limit number of remote environments. When the number of remote environments is not less than the upper limit number of remote environments (NO at step S307), the submission-destination selecting unit 112 adds 1 to the variable b (step S312), and returns to step S304 in an attempt to obtain the next node ID. When the number of remote environments is less than the upper limit number of remote environments (YES at step S307), the submission-destination selecting unit 112 instructs the load-state obtaining unit 115 to obtain the load on a node corresponding to the node ID (step S308).

When the load is higher than a predetermined threshold (NO at step S309), the submission-destination selecting unit 112 adds 1 to the variable b (step S312), and returns to step S304 in an attempt to obtain the next node ID. When the obtained load is lower than a predetermined threshold (YES at step S309), the submission-destination selecting unit 112 instructs the license checking unit 114 to check whether a license violation occurs if a new remote environment created on the node is selected as a destination to submit the job to. According to the instruction from the submission-destination selecting unit 112, the license checking unit 114 checks whether, if all the packages in the package list are installed in a new remote environment on the node, it is a violation of license conditions, for example, on the number of licenses (step S310).

When it is determined that a licenses violation is to occur (NO at step S311), the license checking unit 114 informs the submission-destination selecting unit 112 of this fact. The submission-destination selecting unit 112 adds 1 to the variable b (step S312), and returns to step S304 in an attempt to obtain the next node ID. When it is determined that a licenses violation is not to occur (YES at step S311), the license checking unit 114 informs the submission-destination selecting unit 112 that there is no license problem. Accordingly, the submission-destination selecting unit 112 selects the node indicated by the node ID obtained at step S304 as a node on which a new remote environment is to be created (step S313).

On the other hand, if the b-th node ID cannot be obtained from the arranged node IDs, i.e., when there is no node on which a remote environment can be created (NO at step S305), the submission-destination selecting unit 112 performs error processing, and terminates the process for the job. In this error processing, for example, the job is returned to the job queue 121, and the selection of a destination to which a job is to be submitted is performed again.

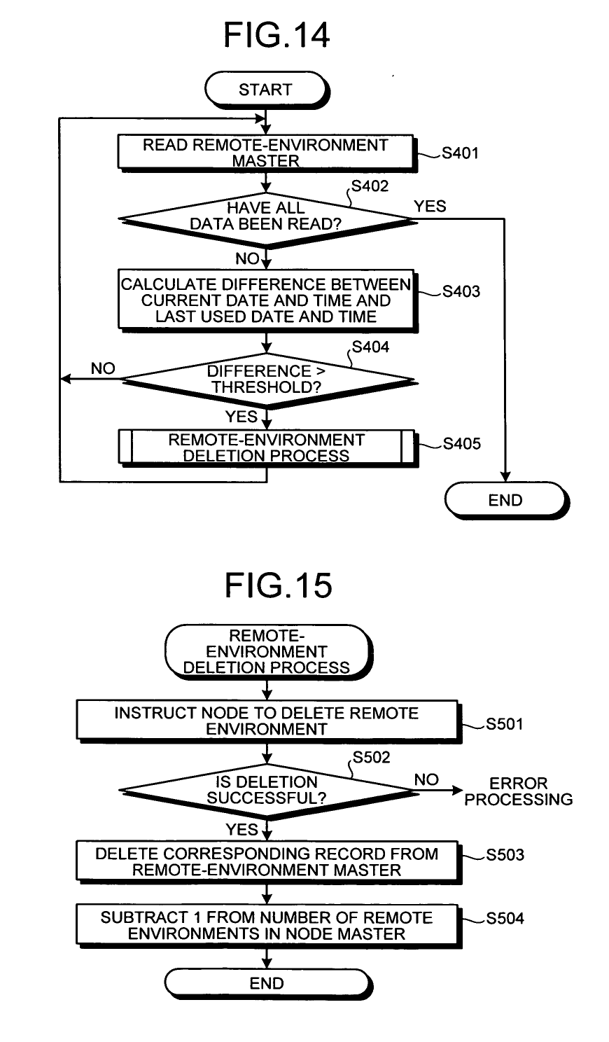

FIG. 14 is a flowchart for explaining the automatic deletion process for automatically deleting a remote environment performed by the job assigning device 100. The job assigning device 100 repeats the process at regular intervals. When the automatic deletion process is activated, the remote-environment deleting unit 117 reads a data set from the remote environment master 122e (step S401). When all data sets have already been read (YES at step S402), the remote-environment deleting unit 117 terminates the automatic deletion process. When a data set can be read from the remote environment master 122e (NO at step S402), the remote-environment deleting unit 117 calculates the difference between the current date and time and the last used date and time in the data set (step S403). If the difference is less than a predetermined threshold (NO at step S404), the remote-environment deleting unit 117 returns to step S401 to read the next data set. If the difference exceeds the predetermined threshold (YES at step S404), the remote-environment deleting unit 117 performs the remote-environment deletion process, which is described hereinafter (step S405). After that, the remote-environment deleting unit 117 returns to step S401 in an attempt to read the next data set.

FIG. 15 is a detailed flowchart of the remote-environment deletion process at step S405 in FIG. 14. The emote-environment deletion process is also performed when data on a user is deleted from the user master 122a to delete all remote environments for the user. The remote-environment deleting unit 117 informs each node, on which a remote environment to be deleted exists, of a remote environment ID to cause the node to delete the remote environment (step S501). If having been informed by the node that the remote environment was not deleted successfully (NO at step S502), the remote-environment deleting unit 117 performs error processing, and terminates the process for the remote environment. In this error processing, for example, the reported error information, etc. is recorded in an error log. On the other hand, if having been informed by the node that the remote environment was deleted successfully (YES at step S502), the remote-environment deleting unit 117 deletes data on the remote environment from the remote environment master 122e (step S503), and subtracts 1 from the number of remote environments corresponding to the node in the node master 122d (step S504).

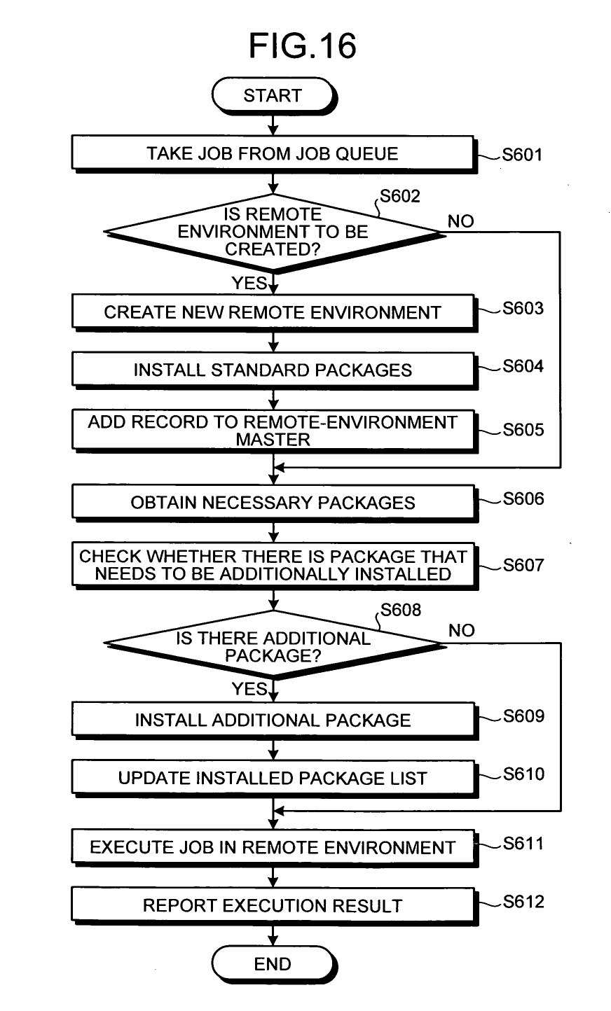

FIG. 16 is a flowchart for explaining the operation of the nodes 300 to 302 to execute a job. The flowchart shows the process from when the node (300 to 302) takes a job from the job queue 321 until when the node (300 to 302) returns the result of execution. The nodes 300 to 302 each repeat the process.

First, the job executing unit 312 takes a job from the job queue 321 (step S601). The job executing unit 312 refers to the remote environment master 324 to obtain the location where exists a remote environment corresponding to a remote environment ID associated with the job. If the remote environment master 324 does not contain the remote environment ID (YES at step S602), the job executing unit 312 instructs the remote-environment managing unit 314 to create a new remote environment. According to the instruction from the job executing unit 312, the remote-environment managing unit 314 creates an initial-state remote environment in the remote environment creating area 323 (step S603). The remote-environment managing unit 314 installs standard packages in the created remote environment (step S604), and adds data on the remote environment to the remote environment master 324 (step S605).

The job executing unit 312 instructs the software-information obtaining unit 313 to obtain a list of packages (package list) required to execute the job (step S606). The job executing unit 312 feeds the remote-environment managing unit 314 with a remote environment ID and the obtained package list, and instructs the remote-environment managing unit 314 to install additional packages in the remote environment indicated by the remote environment ID. Having received the instruction, the remote-environment managing unit 314 compares the package list with the installed package list corresponding to the remote environment ID in the remote environment master 324 to check whether there is any package that needs to be additionally installed (step S607). If any (YES at step S608), the remote-environment managing unit 314 obtains the necessary package from the package storing area 322 or the like, and installs the package (step S609). The remote-environment managing unit 314 updates the installed package list in the remote environment master 324 so that the installed package list contain package IDs of all packages in the package list (step S610). After that, the job executing unit 312 executes the job in the remote environment indicated by the remote environment ID (step S611), and informs the job assigning device 100 of the result of the execution (step S612).

The job assigning device 100 and the nodes 300 to 302 are explained above as hardware; however, they can be implemented in software. In other words, a computer program previously prepared can be executed on a computer to realize the same functions as each of the job assigning device 100 and the nodes 300 to 302. In the following, a computer that executes a computer program to realize the functions of the job assigning device 100 is explained.

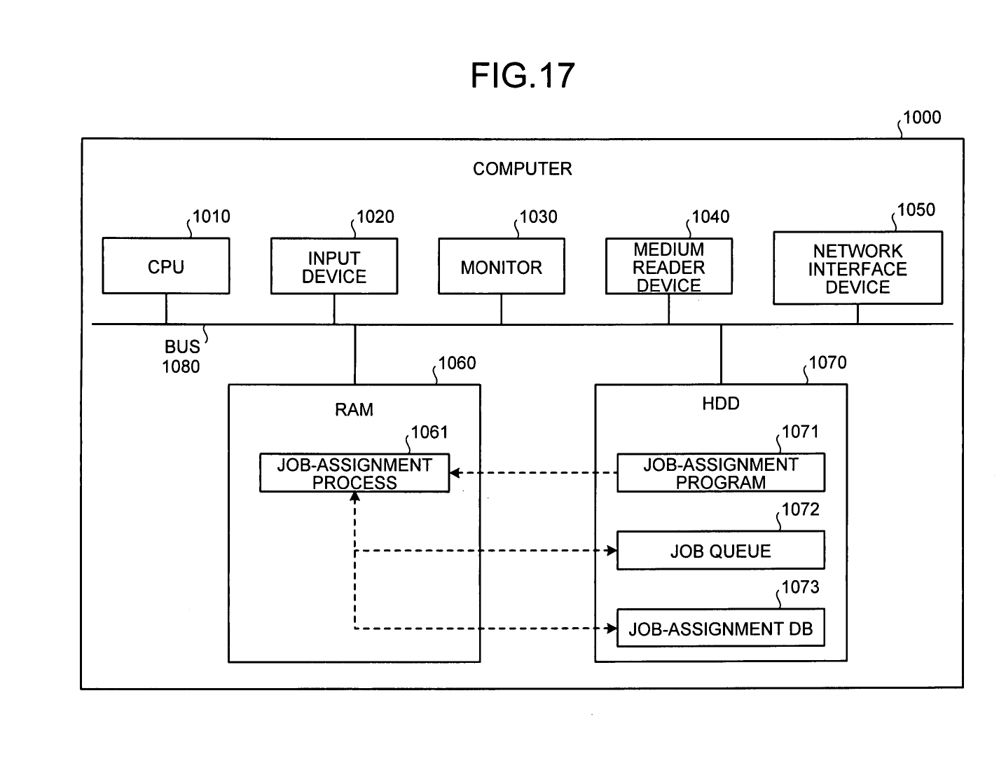

FIG. 17 is a functional block diagram of a computer 1000 that executes a job-assignment program 1071 to implement the methods, processes, or steps explained above. The computer 1000 includes a CPU 1010, an input device 1020, a monitor 1030, a medium reader device 1040, a network interface device 1050, a random access memory (RAM) 1060, a hard disk drive (HDD) 1070, and a bus 1080. The CPU 1010 executes various operation processes. The input device 1020 is used by a user to enter data. The monitor 1030 displays a variety of information. The medium reader device 1040 reads programs, etc. from a recording medium. The network interface device 1050 exchanges data with other computers via a network. The RAM 1060 temporarily stores a variety of information. The bus 1080 connects these components together.

The HDD 1070 stores the job-assignment program 1071 to realize the functions of the job assigning device 100 shown in FIG. 3. The HDD 1070 includes a job queue 1072 and a job assignment DB 1073 corresponding to the job queue 121 and the job assignment DB 122, respectively. Incidentally, the job assignment DB 1073 can be divided and distributed to other computers connected via the network. The job-assignment program 1071 is loaded from the HDD 1070 into the RAM 1060 and executed by the CPU 1010 as a job-assignment process 1061. The job-assignment process 1061 loads information, etc. into an area assigned thereto when required, and performs various functions, such as data processing, based on the information, etc.

Incidentally, the job-assignment program 1071 is not necessarily stored in the HDD 1070. The computer 1000 can read the job-assignment program 1071 stored in a storage medium such as a compact disc read only memory (CD-ROM), and execute the job-assignment program 1071. Alternatively, the computer 1000 can read the job-assignment program 1071 stored in another computer connected via a public line, the Internet, a local area network (LAN), a wide area network (WAN) or the like, and execute the job-assignment program 1071. In addition, a computer program (job-execution program) can be executed on a computer similar to the computer 1000 to realize the same functions as the controlling unit 310 shown in FIG. 9.

As set forth hereinabove, according to an embodiment of the present invention, information on software required to execute a job is obtained. Based on the information, a remote environment to which the job is to be submitted is selected, or a new remote environment is created, and, if necessary, additional software is installed in the remote environment. Thus, in a grid system where various types of remote environments exist, the remote environments can be autonomously and effectively operated. In addition, each job can be submitted to an appropriate remote environment, and also, when there is no remote environment selectable as a destination to submit a job to, a new remote environment is created on an appropriate node.

Besides, when a remote environment is selected as a destination to submit a job to, information on installed software is updated to indicate that all software required to execute the job has been installed in the remote environment or a node on which the remote environment exists. Thereby, the change in the installed software can be properly reflected in the subsequent selection of a destination to submit a job to or a node to create a new remote environment. Moreover, information on software required to execute a job is sent to a node together with the job, which facilitates additional installation of software by the node.

Further, license check is performed before the submission of a job. When the job requires software for which a license has not been obtained, processing of the job is terminated. When it is a violation of license conditions if software required to execute the job is installed in a remote environment, the job is not to be submitted to the remote environment. Thus, each job can be submitted properly.

Still Further, when the registration of a user is cancelled, one or more remote environments for the user are deleted. Namely, unnecessary remote environments can be cleared automatically.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to receive a job from a first user terminal among a plurality of user terminals and submits the job to a remote environment from among a plurality of remote environments in a first node among a plurality of nodes that constitute a grid, the computer program causing the computer to execute:
obtaining software information indicating software required to execute the job from the first user terminal;
obtaining remote-environment information corresponding to the first user terminal, wherein the remote-environment information indicates one or more remote environments and software installed in each of the remote environments;
comparing obtained remote-environment information with obtained software information and determining a remote environment in which largest number of copies of the software required to execute the job have been installed;
preferentially selecting identified remote environment as a destination for submitting the job; and
submitting the job to selected remote environment.

2. The computer-readable recording medium according to claim 1, wherein the selecting includes updating the remote-environment information to indicate that all the software indicated by the software information has been installed in the selected remote environment.

3. The computer-readable recording medium according to claim 1, wherein the selecting includes transmitting the job together with the software information to a node on which the selected remote environment exists.

4. The computer-readable recording medium according to claim 1, wherein, when there is no remote environment selectable as a destination to submit the job to, the computer program further causes the computer to execute:
obtaining node information indicating software installed in each node;
comparing the node information with the software information to identify a node on which the largest number of copies of the software required to execute the job have been installed; and
preferentially selecting the node to crate a new remote environment as a destination to submit the job to.

5. The computer-readable recording medium according to claim 4, wherein the selecting includes updating the node information to indicate that all the software indicated by the software information has been installed in the selected node on which the new remote environment is to be created.

6. The computer-readable recording medium according to claim 1, wherein, when the software indicated by the software information includes software that requires a license, the computer program further causes the computer to execute:
obtaining license information from the first user terminal;
deciding whether the first user terminal has a license to use the software based on the license information; and
not submitting the job to the first node when it is decided at the deciding that the first user terminal has not acquired the license.

7. The computer-readable recording medium according to claim 6, wherein
the deciding includes checking whether it is a violation of license conditions indicated by obtained license information if the software indicated by the software information is installed in a remote environment, and, when it is a violation of the license conditions, setting the remote environment as a license-violating remote environment, and
the selecting includes removing the license-violating remote environment from candidates for a destination to submit the job to.

8. The computer-readable recording medium according to claim 1, wherein, when registration of the first user terminal is cancelled, the computer program further causes the computer to execute:
extracting the one or more remote environments for the user referring to the remote-environment information; and
instructing each node on which extracted remote environment exists to delete the extracted remote environment.

9. The computer-readable recording medium according to claim 8, wherein the computer program further causes the computer to execute:
storing information on time and date when a remote environment is selected as a destination to submit a job to in association with the remote environment;
extracting a remote environment that has not been selected as a destination to submit a job to for a predetermined period of time; and
instructing a node on which extracted remote environment exists to delete the extracted remote environment.

10. A job assigning device that receives a job from a first user terminal among a plurality of user terminals and submits the job to a remote environment from among a plurality of remote environments in a first node among a plurality of nodes that constitute a grid, the job assigning device comprising:
a software-information obtaining unit that obtains software information indicating software required to execute the job from the first user terminal;
a storage unit that stores therein a correspondence of user terminals and remote-environment information of each of the nodes, wherein the remote-environment information indicates one or more remote environments and software installed in each of the remote environments;
a remote-environment-information obtaining unit that obtains remote-environment information corresponding to the first user terminal from the storage unit;
a comparing unit that compares the remote-environment information obtained by the remote-environment-information obtaining unit with the software information obtained by the software-information obtaining unit and determines a remote environment in which largest number of copies of the software required to execute the job have been installed;
a selecting unit that preferentially selects the remote environment identified by the comparing unit as a destination for submitting the job; and
a job submitting unit that submits the job to the remote environment selected by the selecting unit in the first node.

11. A job assigning method of receiving a job from a first user terminal among a plurality of user terminals and submits the job to a remote environment from among a plurality of remote environments in a first node among a plurality of nodes that constitute a grid, the job assigning method comprising:
obtaining software information indicating software required to execute the job from the first user terminal;
obtaining remote-environment information corresponding to the first user terminal, wherein the remote-environment information indicates one or more remote environments and software installed in each of the remote environments;
comparing obtained remote-environment information with obtained software information and determining a remote environment in which largest number of copies of the software required to execute the job have been installed;
preferentially selecting identified remote environment as a destination for submitting the job; and
submitting the job to selected remote environment.

12. A computer-readable recording medium that stores therein a computer program that causes a computer to receive a job from a user terminal and submit the job to a remote environment in a first node among a plurality of nodes that constitute a grid, the computer program causing the computer to execute:
obtaining software information indicating software required to execute the job from the first user terminal;
selecting a remote environment as a destination to submit the job to;
obtaining remote-environment information corresponding to selected remote environment, indicating software installed in the selected remote environment; and
comparing the remote-environment information with the software information to determine whether there is a need to install additional software to execute the job; and
installing, when there is a need to install additional software, the additional software in the selected remote environment.

13. The computer-readable recording medium according to claim 12, wherein the installing includes updating the remote-environment information to indicate that all the software indicated by the software information has been installed in the selected remote environment.

14. The computer-readable recording medium according to claim 12, wherein the installing includes performing any one of copying files in the selected remote environment, and creating links that allow access to the files from the selected remote environment.

15. A job executing method of receiving a job from a user terminal and submitting the job to a remote environment in a first node among a plurality of nodes that constitute a grid, the job executing method comprising:
obtaining software information indicating software required to execute the job from the first user terminal;
selecting a remote environment as a destination to submit the job to;
obtaining remote-environment information corresponding to selected remote environment, indicating software installed in the selected remote environment; and
comparing the remote-environment information with the software information to determine whether there is a need to install additional software to execute the job; and
installing, when there is a need to install additional software, the additional software in the selected remote environment.
